(19) United States
(12) Patent Application Publication
(10) Pub. No.: US 2018/0193803 A1
(43) Pub. Date: Jul. 12, 2018

(54) COPOLYMER NANOFILTERS WITH CHARGE-PATTERNED DOMAINS

(71) Applicant: University of Notre Dame du Lac, South Bend, IN (US)

(72) Inventors: William A. PHILLIP, South Bend, IN (US); Siyi Qu, South Bend, IN (US); Yi Shi, South Bend, IN (US)

(73) Assignee: University of Notre Dame du Lac, South Bend, IN (US)

(21) Appl. No.: 15/866,246

(22) Filed: Jan. 9, 2018

Related U.S. Application Data
(60) Provisional application No. 62/444,322, filed on Jan. 9, 2017.

(51) Int. Cl. B01D 67/00; C08J 9/28; C08J 9/36; B01D 71/80; B01D 61/02

(52) U.S. Cl. CPC B01D 67/0093; C08J 9/28; C08J 9/365; B01D 71/80; B01D 61/027; B01D 2323/36; C08J 2201/0543; C08J 2205/042; C08J 2333/20; C08J 2333/14; B01D 2323/22; B01D 67/0009

(57) ABSTRACT

The further advancement of membrane separation processes requires the development of more selective membranes. In this study, membranes that take inspiration from biological systems and use multiple functionalities of unique chemical design to control solute transport through chemical factors in addition to steric factors are detailed. Specifically, copolymer materials tailor-made for the generation of nanofilters that possess a high density of well-defined pores lined by azido moieties allowed for the generation of chemically-patterned mosaic membranes in a rapid manner through the use of printing devices. By engineering the composition of the reactive ink solutions used for chemical functionalization, large areas of patterned membranes were generated in seconds rather than hours. Charge mosaic membranes were used as an example of this novel platform.

### RELATED APPLICATIONS

This application claims priority under 35 U.S.C. § 119(e) to U.S. Provisional Patent Application No. 62/444,322, filed Jan. 9, 2017, which is incorporated herein by reference.

### GOVERNMENT SUPPORT

This invention was made with government support under Grant No. UL1TR001108 awarded by the National Institutes of Health. The government has certain rights in the invention.

### BACKGROUND OF THE INVENTION

Membrane separation processes play a critical role in the purification of drinking water,^{1, 2} the processing of electronics,³ and the development of therapeutic medicine.^{4, 5} In most state-of-the-art applications, the semi-permeable membrane that is crucial to these processes functions by a filtration mechanism that rejects large molecules and allows the passage of small molecules.⁶⁻⁸ Catalyzed by recent advances in the synthesis and assembly of nanoscale materials, there is a growing interest in the production of higher performance (i.e., more perm-selective) membranes.⁹⁻¹³ While improved throughput may be advantageous in some applications, a growing body of literature suggests that more selective membranes, which are better able to distinguish between molecules of a comparable size, have greater potential to provide step-changes in the design and performance of membrane processes.¹⁴⁻¹⁸

Nanostructured membranes inspired by biological analogues provide one possible route toward the realization of more selective separations devices based on advanced materials. Due to their mosaic structure at the nanoscale, which consists of multiple membrane proteins of unique chemical design working synergistically to control solute transport, biological membranes (e.g., the cell wall) are able to transport chemical species rapidly and with near perfect selectivity.¹⁹⁻²⁴ Current synthetic membranes, which are typically based on a single material chemistry, do not provide this level of control over mass transfer. As such, developing synthetic membrane platforms that mimic the exquisite processes of biology more efficiently and effectively would provide a route toward performing myriad chemical separations that are critical to modern society.^{25, 26}

Charge mosaic membranes are a class of membranes that draw inspiration from the mosaic nanostructure of biological membranes. These novel membranes consist of distinct cationic and anionic domains that traverse the membrane thickness.^{27, 28} Due to this bio-inspired nanostructure, these membranes allow for the rapid permeation of dissolved electrolytes through their counter-charged domains at higher rates than similarly-sized neutral molecules or solvent.^{29, 30} This novel transport mechanism, known as negative osmosis, may make it possible to remove dilute ionic contaminants (e.g., nitrate) from water supplies by facilitating the selective transport of the contaminants over water.³¹ However, materials and material processing challenges have hindered the wide-spread adoption and usage of charge mosaic membranes. Accordingly, new materials and methods are needed for improved charge mosaic membranes.

### SUMMARY

The invention provides copolymer nanofilters with charge-patterned domains. The nanofilters can be used for enhanced electrolyte transport and filtration. The nanofilters can have a high density of well-defined pores lined by azido moieties allowing for the generation of chemically-patterned mosaic membranes in a rapid manner through the use of printing devices. The nanofilters can include charged mosaic membranes, wherein the membranes possess distinct cationic and anionic domains that traverse the membrane thickness, which allows for the emergence of negative osmosis.

The nanofilters are therefore membranes that have pores on their surfaces. The pores have side walls that enclose a volume of space that creates a pathway from one side of the membrane to another side of the membrane. These pathways can be straight, branched, and/or winding. Pathways extending from one side to the other side of a membrane may intersect. The invention provides methods for functionalizing these pores to provide mosaic membranes with new charge transport properties.

The invention therefore provides a membrane comprising a plurality of pores, wherein active chemical moieties are covalently attached to the pore wall of one or more pores by one or more intermediary copolymer groups, and the membrane is selective toward the separation of particles of similar size based on particle charge.

The active chemical moieties comprise azido groups, hydroxyl groups, triazole groups, amine groups, carboxyl groups, or a combination thereof. In various embodiments, the azido groups can be functionalized to substituted triazoles, wherein the triazoles are substituted with amine groups or carboxyl groups. The membrane can then be treated with an acid or base to provide active chemical moieties that are carboxylate anions or ammonium cations thereof, respectively. In some embodiments, at least 50%, at least 75%, at least 85%, at least 90%, or at least 95% of the azido groups can be converted to the substituted triazole moieties, thereby modulating the selective separation properties.

In some embodiments, the active chemical moieties comprise moiety I, moiety II, or a combination thereof:

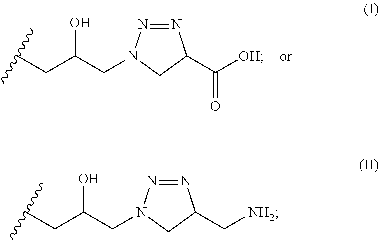 [SMILES: *CC(O)CN1CC(C(=O)O)N=N1 ; *CC(O)CN1CC(CN)N=N1]

or a carboxylate anion or ammonium cation thereof, respectively. Moieties I and II are attached to an oxygen atom of the ester of a glycidyl methacrylate block of the copolymer, where one or more of the glycidyl moieties have been converted to azido alcohols, and the azido groups have been reacted to form the triazole moieties of moieties I and II. In certain specific embodiments, the membrane comprises ammonium cations of active chemical moieties of moiety II and the membrane comprises a residual positive charge. In other specific embodiments, the membrane comprises carboxylate anions of active chemical moieties of moiety I and the membrane comprises a residual negative charge. In further embodiments, the membrane can include a combination thereof. Accordingly, the membrane can have pores having residual positive charges and other pores having residual negative charges.

In one embodiment the intermediary copolymer (e.g., a copolymer bond to a membrane support) comprises a copolymer of Formula III:

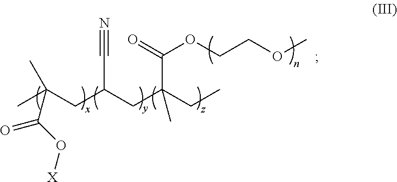

wherein each X is independently an active chemical moiety. The active chemical moieties can be any one or more of the active chemical moiety described above. In one embodiment, the active chemical moieties comprise moiety I, moiety II, or a carboxylate anion or ammonium cation thereof, respectively. The variable n can be about 5 to about 5,000; x can be about 5 to about 10,000; y can be about 5 to about 10,000; and z can be about 5 to about 10,000; wherein one or more nitrile groups of block y form a covalent bond with a pore wall of the membrane support structure (e.g., a PAN-400 substrate). In some embodiments, the membrane support structure can be a porous ultrafiltration membrane, such as a polyacrylonitrile membrane (e.g., those commercially available from suppliers such as Nanostone Water, Oceanside, Calif.). In some embodiments, the pores of the membrane support structure can be about 2-8 nm in diameter, about 4-6 nm in diameter, or about 5 nm in diameter, on average.

In some embodiments, the surface charge density of the membrane is about 0.01 to about 0.001 μcoul cm⁻². In various embodiments, the average pore sizes of the membrane are about 3 nm to about 7 nm.

The invention also provides a filtration membrane comprising a plurality of pores wherein a block copolymer is attached to the sidewall of one or more pores, free ends of the copolymer extending into the pore are functionalized by anionic charged species, cationic charged species, or a combination thereof, and wherein different regions of the membrane comprises pores with net positive charges and net negative charges, respectively.

The copolymer can include at least three polymer blocks, wherein a first block is hydrophilic, a second block is hydrophobic, and the third block is functionalized with a positively or negatively charged specie. One of the blocks can comprise poly(ethylene oxide). The order of the blocks is generally random. In one embodiment, copolymer is functionalized P(AN-OEGMA-AHPMA), wherein the functionalization is optionally the addition of the active chemical moieties described herein. In some embodiments, azido group, i.e., from the AHPMA block, binds to the membrane support, which in one embodiment is a porous polyacrylonitrile membrane or PAN-400.

The invention further provides a method of forming a mosaic polymer membrane comprising: dissolving P(AN-OEGMA-AHPMA) copolymer in a suitable solvent to provide a solution; combining the solution of P(AN-OEGMA-AHPMA) copolymer with a membrane substrate that has a plurality of pores; fabricating the polymer membrane by bonding polyacrylonitrile moieties of the P(AN-OEGMA-AHPMA) polymer to the sidewalls of one or more pores of the membrane substrate; and functionalizing azido groups of the copolymer by a CuAAC click reaction with a charged species; wherein different regions of the membrane are functionalized with either positive or negative charged species.

Thus, a copolymer such as P(AN-OEGMA-GMA/AHPMA) can be coated on top of a substrate (e.g., a PAN-400 substrate) to cast the combined membrane. The copolymer can partially or completely enter the pores of the substrate or the copolymer can form a filtration membrane outside and/or over pores of the substrate. The substrate can have much larger pores and merely provides structural support for the filtration copolymer. The reactive inks that create residual charges on the functionalized AMPHA, which is converted from the GMA structure, line the pore walls of the membrane after casting, and have pore sized as described herein (e.g., 3-7 nm, 4-6 nm, or about 5 nm).

The charges species can include propargylamine, propiolic acid, or a combination thereof. These species can be used in the form of an ink mixture that includes a dye, such as the dyes described herein. The azido groups can be functionalized by printing the charged species in a pattern on the polymerized membrane substrate, as also described herein.

The invention yet further provides a method of rapidly preparing an area of a patterned membrane, e.g., comprising the mosaic membrane described herein, comprising printing a reactive ink solution onto a suitable porous membrane to provide a mosaic membrane for the selective filtration of particles of similar size based on particle charge. The printing provides rows of multiple oppositely-charged materials resulting in a membrane having negative osmosis properties, as described herein.

### BRIEF DESCRIPTION OF THE DRAWINGS

The drawings shown herein form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1. Schematic illustration of ink-jet printing process used to generate functional patterns on nanostructured membranes. A self-assembled copolymer membrane with reactive functional groups lining the pore walls was used as a substrate. Activated inks were deposited onto the nanostructured substrate using an inkjet printer in order to pattern the surface chemistry of the membrane. As such, nanostructured mosaic membranes could be generated in a rapid and systematic manner.

FIG. 2. ¹H NMR spectra and chemical structures of the copolymers prepared in this study. The characteristic double peaks labeled c demonstrate the presence of the epoxy groups in the poly(acrylonitrile-co-oligo(ethylene glycol) methyl ether methacrylate-co-glycidyl methacrylate) (P(AN-OEGMA-GMA)) material. After the ring-opening reaction with sodium azide, the characteristic double peaks disappear and new peaks associated with the poly(acrylonitrile-co-[oligo(ethylene glycol) methyl ether methacrylate]-co-(3-azido-2-hydroxypropylmethacrylate)) (P(AN-OEGMA-AHPMA)) structure appear (Hameed et al., Soft Matter 2010, 6, 6119-6129). In particular, the peak labeled g, which corresponds to the hydroxyl groups, demonstrates the success of the ring opening reaction (Zhang et al., Polym. Chem. 2012, 3, 1016-1023).

FIG. 3. ATR-FTIR spectra of the functionalized copolymer membranes at each step of chemical modification and the corresponding functional groups attached to pore walls. From bottom to top: i. The peak a at ˜908 cm⁻¹ corresponds to the antisymmetric ring deformation band of the epoxide group in PGMA of a P(AN-OEGMA-GMA) membrane; ii. the epoxide peak disappeared and a characteristic peak b corresponding to the azide moieties appeared at ˜2100 cm⁻¹ for the P(AN-OEGMA-AHPMA) membrane; iii. an azide-functionalized membrane reacted with propiolic acid for 3 min resulted in a negatively-charged, anionic membrane; iv. an azide-functionalized membrane reacted with propargylamine for 3 min resulted in a positively-charged, cationic membrane. In both cases, the disappearance of the characteristic azide peak indicates complete reaction.

FIG. 4. The effects of functionalization on the chemistry and nanostructure of copolymer membranes. a. Streaming current measurement as a function of pH for the parent, cationic, and anionic membranes. The streaming current was measured using a 10 mM KCl solution. A pressure of 15 psi was applied to the cell connected to positive terminal of current meter. The pH of KCl solution was adjusted using HCl or KOH. b. Solutes rejection curves for an azide-functionalized parent membrane and a printed mosaic membrane. The membranes were challenged with feed solutions containing neutral solutes. Feed solutions were prepared by dissolving sucrose (342 g mol⁻¹) or PEO with a molecular weight of 1.1, 2.1, 4.0 and 9.8 kg mol⁻¹ at a concentration of 1 g L⁻¹ in DI water. Rejection was calculated from the ratio of the solute concentration in the permeate to the feed solutions.

FIG. 5. The effects of printing conditions on the transport properties of charge-functionalized membranes. a. The amount of reactive azide moieties converted to charge-functionalized moieties as a function of the number of overprints was quantified by analyzing the area under the characteristic azide peak (˜2100 cm⁻¹). Specifically, the area under the peak in the shaded region was integrated to estimate azide group conversion. b. Azido conversion as a function of the number of overprints was calculated by taking the ratio of azide peak area of a printed membrane to the unreacted, parent membrane (N=0). The dashed blue line (top line) represents the conversion value obtained by executing the reaction in solution. Applied vacuum value corresponds to 12 psi. c. Magnesium chloride (MgCl₂) rejection by cationic membranes printed with varied number of overprints. 10 mM MgCl₂ dissolved in DI water was used as the feed solution. d. Sodium sulfate (Na₂SO₄) rejection by anionic membranes printed with varied number of overprints. 10 mM Na₂SO₄ dissolved in DI water was used as the feed solution. An applied pressure of 60 psi was used in all of the rejection experiments.

FIG. 6. Fluorescent micrographs of mosaic membranes patterned by inkjet printing. a. A dotted pattern of propiolic acid was printed on an azide-functionalized membrane at a resolution of 90 dpi. b. A striped pattern of proparyglamine was printed on an azide-functionalized membrane using a resolution of 300 dpi. The interstitial region between stripes was left unreacted. c. A striped mosaic pattern of proparyglamine and propiolic acid was printed on an azide-functionalized membrane. In all cases, after printing the membrane was submerged in a sulfo-cyanine5 alkyne solution for 8 h and then washed with excess DI water for 24 h before imaging. Micrographs were collected under the cy5 wavelength.

FIG. 7. Solute rejection properties of printed charge mosaic membranes. a. Rejection of charged and neutral solutes for the parent, anionic, cationic and mosaic functionalized membranes. 1 g L⁻¹ sucrose was used as a neutral solute. All salts were dissolved in DI water at a concentration of 10 mM. b. Potassium chloride (KCl) rejection as a function of the feed solution concentration for anionic, cationic, and mosaic functionalized membranes. KCl was dissolved in DI water. An applied pressure of 60 psi was used in all experiments.

FIG. 8. Timed series characterization of copper(I)-catalyzed azide-alkyne cycloaddition (CuAAC) click reactions for P(AN-OEGMA-AHPMA) membranes. The conversion of the azido group was quantified using the characteristic peak a at 2100 cm⁻¹ in the FT-IR sprectra (Shi et al., J. Polym. Sci., Part A: Polym. Chem. 2015, 53, 239-248). The P(AN-OEGMA-AHPMA) membrane, which corresponds to absorption spectrum i (bottom line), was analyzed as the control (i.e., 0% conversion). The CuAAC reaction initiates when the membrane contacts the reactive ink solution. After 1 min exposure (spectrum ii; second from bottom) to the reactive ink solution, the characteristic azido peak is significantly diminished. At 3 min exposure (spectrum iii; third from bottom), nearly complete conversion is observed due to the disappearance of the characteristic azido peak.

FIG. 9. Printing a 1000-μm-wide stripe using different resolutions (i.e., dots per inch (dpi)) and number of overcoats. The printer was programmed to produce a 1000-μm-wide stripe, which appears dark in the micrographs, using a series of operating parameters. a. 20 overcoats 360 dpi, b. 10 overcoats 360 dpi, c. 10 overcoats 180 dpi, d. 10 overcoats 90 dpi. At low resolution, single droplets of solution produce distinct circles. As the resolution is increased, the droplets begin to overlap and eventually form solid lines at sufficiently high resolution. Based on these results, a resolution of 360 dpi and 20 overprints was used to produce bio-inspired mosaic membrane structures.

FIG. 10. FT-IR spectra and corresponding fluorescent micrograph of various copolymer membranes after exposure to a reactive ink solution containing the fluorescent ay-sulfo-cyanine5 dye.

### DETAILED DESCRIPTION

The further advancement of membrane separation processes requires the development of more selective membranes. In this study, membranes that take inspiration from biological systems and use multiple functionalities of unique chemical design to control solute transport through chemical factors in addition to steric factors are detailed. Specifically, copolymer materials tailor-made for the generation of nanofilters that possess a high density of well-defined pores lined by azido moieties allowed for the generation of chemically-patterned mosaic membranes in a rapid manner through the use of printing devices. By engineering the composition of the reactive ink solutions used for chemical functionalization, large areas of patterned membranes were generated in seconds rather than hours as detailed in previous reports.

Charge mosaic membranes, in particular, were used as an example of this novel platform. These membranes possess distinct cationic and anionic domains that traverse the membrane thickness, which results in the emergence of negative osmosis. As demonstrated through transport testing, this novel transport mechanism results in the preferential permeation of electrolytes over neutral molecules and solvents. The versatile and precise control over membrane chemistry at the nanoscale provided by the technique indicates that it can be engineered to prepare a variety of highly-selective mosaic membranes.

### Definitions

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements. When values are expressed as approximations, by use of the antecedent “about,” it will be understood that the particular value without the modifier “about” also forms a further aspect.

The term “about” can refer to a variation of ±5%, ±10%, ±20%, or ±25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the term “about” is intended to include values, e.g., weight percentages, proximate to the recited range that are equivalent in terms of the functionality of the individual ingredient, composition, or embodiment. The term about can also modify the end-points of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units are also disclosed. For example, if 10 to 15 is disclosed, then 11, 12, 13, and 14 are also disclosed, individually, and as part of a range. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “contacting” refers to the act of touching, making contact, or of bringing to immediate or close proximity, including at the cellular or molecular level, for example, to bring about a physiological reaction, a chemical reaction, or a physical change, e.g., in a solution, in a reaction mixture, in vitro, or in vivo.

An “effective amount” refers to an amount effective to bring about a recited effect, such as an amount necessary to form products in a reaction mixture. Determination of an effective amount is typically within the capacity of persons skilled in the art, especially in light of the detailed disclosure provided herein. The term “effective amount” is intended to include an amount of a compound or reagent described herein, or an amount of a combination of compounds or reagents described herein, e.g., that is effective to form products in a reaction mixture. Thus, an “effective amount” generally means an amount that provides the desired effect.

P(AN-OEGMA-GMA) is an abbreviation for poly[acrylonitrile-co-oligo(ethylene glycol) methyl ether methacrylate-co-glycidyl methacrylate]. See Scheme 1 below. Fabrication of P(AN-OEGMA-GMA) can be achieved by methods well known in the art, for example, those described by Vannucci et al., ACS Macro Lett. 2015, 4, 872-878. For example, the poly(acrylonitrile-r-oligo(ethylene glycol) methyl ether methacrylate-r-glycidyl methacrylate) (P(AN-r-OEGMA-r-GMA)) copolymer was synthesized using a free radical polymerization mechanism. Four grams of acrylonitrile, 4.0 g of poly(ethylene glycol) methyl ether methacrylate, 2.0 g of glycidyl methacrylate, 0.5 mol % azobis(isobutyronitrile) (AIBN) relative to total amount of monomer, and a stir bar were added to a round-bottom flask containing 30 mL of dimethyl sulfoxide (DMSO). The flask was purged with nitrogen gas for 1 h before heating the system to 60° C. for 20 h. Then, the solution was cooled to room temperature, and the polymer was precipitated in diethyl ether. The polymer was redissolved in DMSO and precipitated in diethyl ether three more times to remove residual monomer. The final product was dried in a vacuum oven for 24 hours.

P(AN-OEGMA-AMPHA) is an abbreviation for poly{acrylonitrile-co-[oligo(ethylene glycol)] methyl ether methacrylate-co-(3-azido-2hydroxypropyl methacrylate)}. See Scheme 1 below.

CuAAC is an abbreviation for Copper(I)-catalyzed azide-alkyne cycloaddition. CuAAC click reactions are copper catalyzed reactions between azide and alkyne groups that provide triazole products. These reactions are well characterized in the art as described, for example, by Kolb, Finn, and Sharpless in Angewandte Chemie Int. Ed., 2001, 40, 2004.

Copolymer Nanofilters with Charge-Patterned Domains for Enhanced Electrolyte Transport

In this work, we leverage the control over structure and chemistry provided by recent advances in the field of nanoscale materials to design and fabricate bio-inspired mosaic membranes from self-assembled copolymer precursors. Recent progress in the generation of membranes from these novel macromolecules has demonstrated that the synthetic flexibility provided by copolymer materials allows for fine control over the nanostructure of membranes through the rationale design of the macromolecular template.^{9, 32, 33} Additionally, recent work has also demonstrated that the nanopore chemistry of these membranes can be tailored to meet the design needs of several applications through clever material design.^{34, 35}

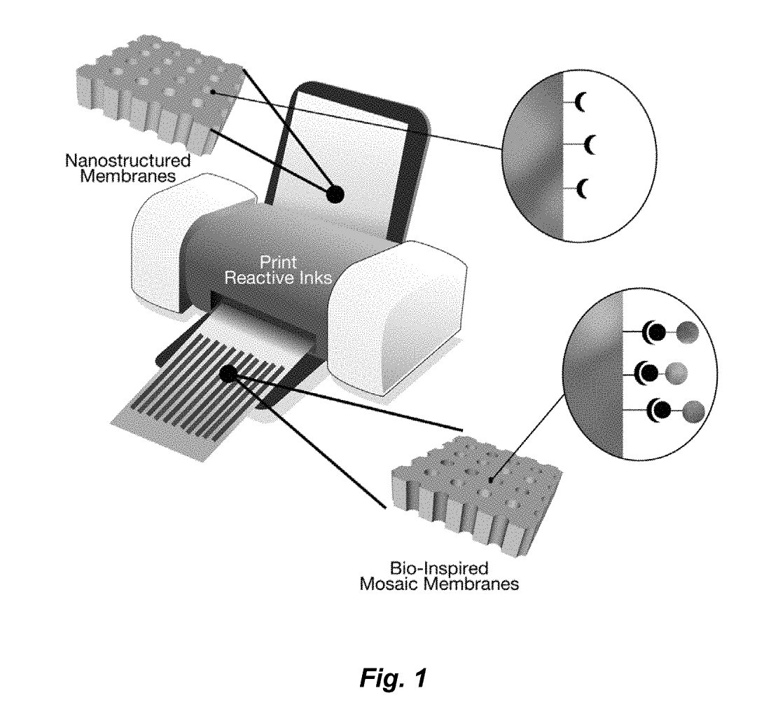

Here, through the development of nanofiltration membranes based on a poly(acrylonitrile-co-[oligo(ethylene glycol) methyl ether methacrylate]-co-(3-azido-2-hydroxypropylmethacrylate)) P(AN-OEGMA-AHPMA) copolymer material, membranes that possess a high density of pores with a uniform pore size are generated. Of critical import to the scalable fabrication of charge mosaics, active chemical moieties amenable to post-synthetic modifications via printing devices are affixed along the surface of the nanopore walls (FIG. 1). By using additive manufacturing approaches, the deposition of multiple oppositely-charged materials was accomplished in a rapid, automated, and efficient manner. Transport tests confirmed that negative osmosis emerged upon chemical patterning of the copolymer membranes, and revealed the exciting potential of these bio-inspired mosaic membranes. The versatility and precise control over substrate chemistry at the nanoscale provided by the reported methodology indicates that this novel class of mosaic membranes will extend the utility of nanostructured membranes for chemical separations.

### Copolymer Synthesis and Characterization

Copolymers with tunable compositions and molecular weights allow for the rational design of macromolecular architectures that meet the varying demands of different membrane systems. This versatility was crucial to the high throughput fabrication of mosaic membranes because printing high-resolution patterns of chemically distinct domains on a nanostructured membrane required the use of pore chemistries that could be functionalized in a rapid manner. Nanofiltration membranes fabricated from a P(AN-OEGMA-AHPMA) copolymer (Scheme 1) met these design criteria. The microphase separation of the hydrophobic PAN moieties, which form the matrix of the membrane, from the hydrophilic poly(ethylene oxide) PEO side chains of the OEGMA repeating unit, which serve as a template for a percolating three-dimensional network of pores, produces highly-effective nanofilters.^{33, 34, 36, 37} The PAHPMA moieties, which line the pore walls (Scheme 2), provide active azido groups that can be modified using copper(I)-catalyzed azide-alkyne cycloaddition (CuAAC) “click” reactions after the well-defined nanostructure of the membrane had been fixed in place.^{38, 39} As such, the azido moieties represent an attractive platform for the rapid and straightforward chemical functionalization of the membrane using printing devices.

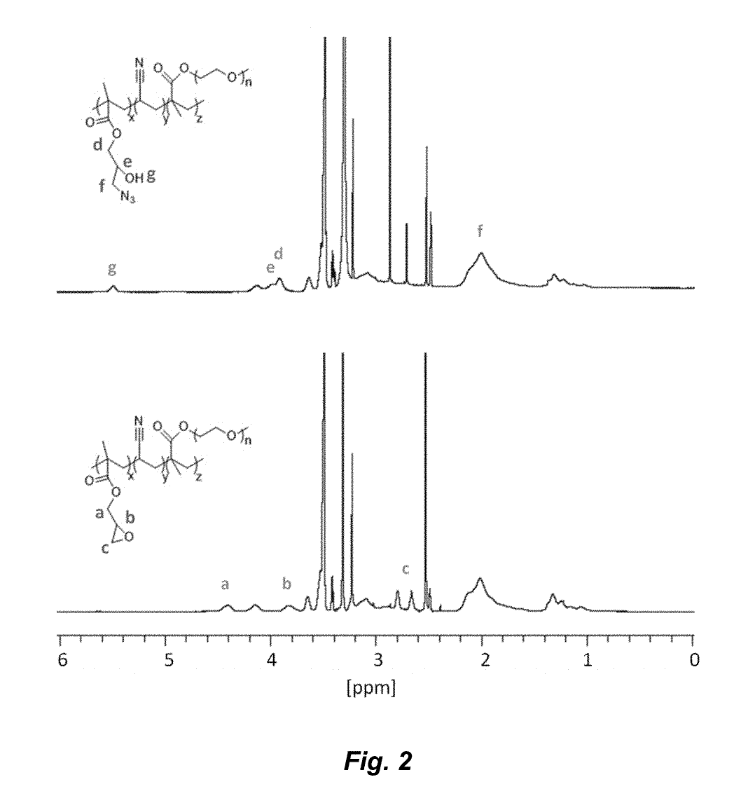

The scheme for the synthesis of the copolymer is illustrated in Scheme 1. A poly(acrylonitrile-co-oligo(ethylene glycol) methyl ether methacrylate-co-glycidyl methacrylate) (P(AN-OEGMA-GMA)) copolymer was first prepared using a free radical copolymerization of the corresponding monomers. Subsequently, ring opening of the oxirane groups in each GMA repeating unit by sodium azide (NaN₃) resulted in the production of the P(AN-OEGMA-AHPMA) material. The chemical structures and compositions of the P(AN-OEGMA-GMA) and P(AN-OEGMA-AHPMA) copolymers were confirmed using ¹H NMR spectroscopy (FIG. 2).

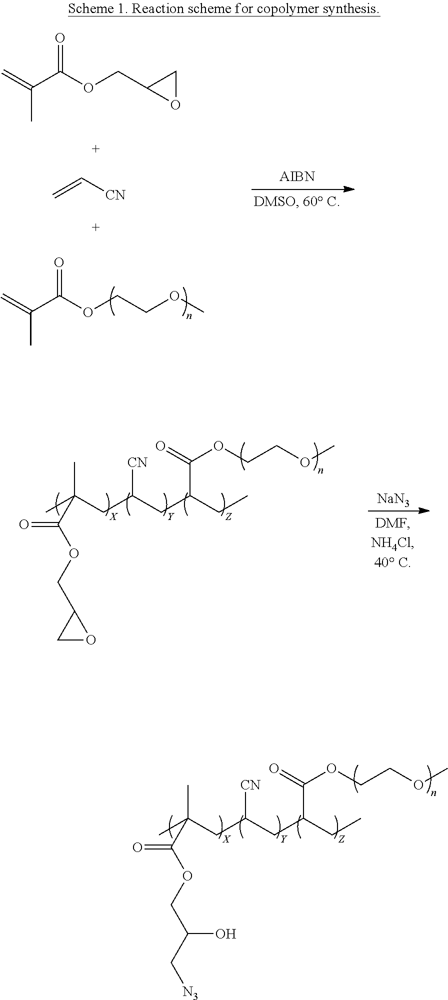

The weight fractions of PGMA (20%), PAN (40%), and POEGMA (40%) in the precursor copolymer calculated from the ¹H NMR spectrum were consistent with the amount of monomer incorporated into the polymerization reaction. The spectrum of the P(AN-OEGMA-AHPMA) material indicated the complete incorporation of the azido groups and also confirmed that the PAN and POEGMA structures remained intact, which was crucial because it is the microphase separation of PAN from POEGMA that results in the formation of a membrane with a high density of well-defined, nanoscale pores.^{34, 36}

In Scheme 1, a P(AN-OEGMA-GMA) copolymer was synthesized using a free radical polymerization. Subsequently, this material was reacted with NaN₃ to produce the P(AN-OEGMA-AHPMA) copolymer used to fabricate membranes (wherein n is about 5 to about 5,000; x is about 5 to about 10,000; y is about 5 to about 10,000; and z is about 5 to about 10,000; or any one or more of n, x, y, or z can be up to about 25,000 or about 50,000).

In Scheme 2, the parent azide-functionalized membrane was cast using a non-solvent induced phase separation method that produces pores lined by the azido moiety. The azido groups on pore wall are converted to charged moieties through a CuAAC click reaction. Membrane regions reacted with propiolic acid possess a residual negative charge due to the carboxylic acid moieties in the pores. Membranes regions reacted with propargylamine possess a residual positive charge due to the amine moieties in the pores.

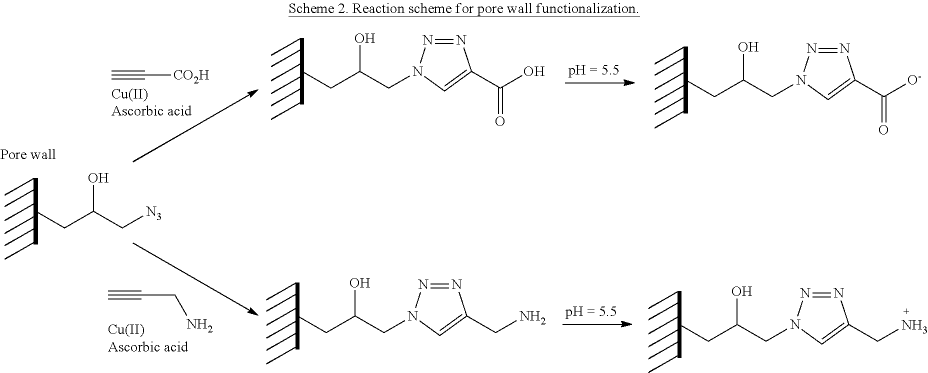

### Membrane Fabrication and Functionalization

Nanoporous membranes were prepared from the P(AN-OEGMA-AHPMA) copolymer using a non-solvent induced phase separation (NIPS) method. The use of the NIPS method allowed the morphology of the membrane to be tuned such that an asymmetric membrane structure with a microphase-separated active layer supported by an underlying macroporous support was generated.⁹ Importantly, the technique helped to ensure that a three-dimensional nanoporous network percolates throughout the active layer of the membrane. This well-defined nanostructure is an ideal precursor for charge mosaic membranes as post-synthetic chemical modifications could be used to produce co-continuous ionic pathways that traverse the membrane thickness. For example, the one-to-one covalent attachment of alkynyl-functionalized charged groups to the azido moieties lining the pore walls enabled the production of charge mosaic membranes. As shown in Scheme 2, positively-charged ammonium moieties and negatively-charged carboxylate moieties could be fixed to the pore wall via reactions with propargylamine and propiolic acid, respectively, to produce nanoporous charge-functionalized domains.

Modification of the copolymer substrates via CuAAC click reaction was implemented because this reaction exhibited several key features necessary for the functionalization of nanostructured membranes using printing devices. The azido moieties incorporated into the membrane substrates react readily with alkynyl groups under mild conditions with very high fidelity.⁴⁰⁻⁴² The kinetics of the CuAAC reaction have been well-established, and are known to be rapid at room temperature in aqueous solutions as well as in a diverse range of organic solvents.^{38, 39, 43, 44} This knowledge allowed for the formulation of inks that dissolved the desired reactants, exhibited fast reaction rates when deposited on the membrane substrate, and avoided damage to both the printer and membranes. The rapid reaction rates were particularly critical for the production of mosaic features because slow reaction rates allow diffusion and other transport mechanisms to spread the reaction zone beyond the preprogramed pattern.

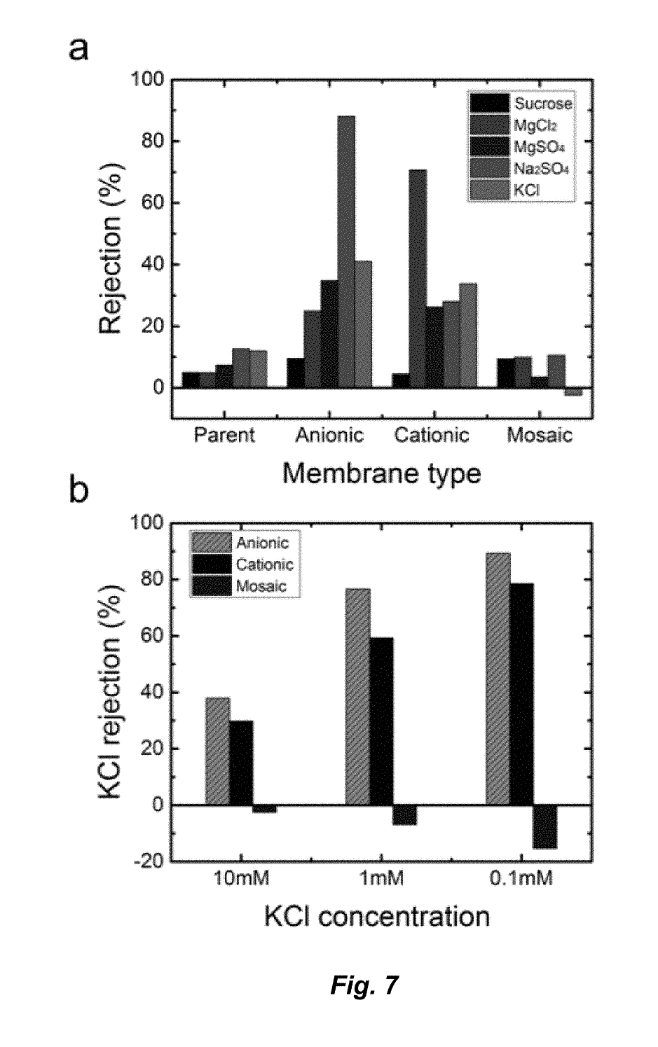

The formulation of the reactive inks was initially studied in solution to ensure that the reaction rate was sufficiently rapid to produce high-resolution features on the membrane surface. Samples of the P(AN-OEGMA-AHPMA) membranes were immersed in aqueous solutions containing either the alkynyl-terminated acid or amine, CuSO₄, and ascorbic acid. Specifically, 20 mM CuSO₄.5H₂O, 60 mM ascorbic acid, and 0.8 M of the alkynyl-terminated reactant were selected for printing studies because the conversion of azido moieties, as determined from a timed series of FT-IR spectra, was almost complete after 3 min under this condition (FIG. 8).

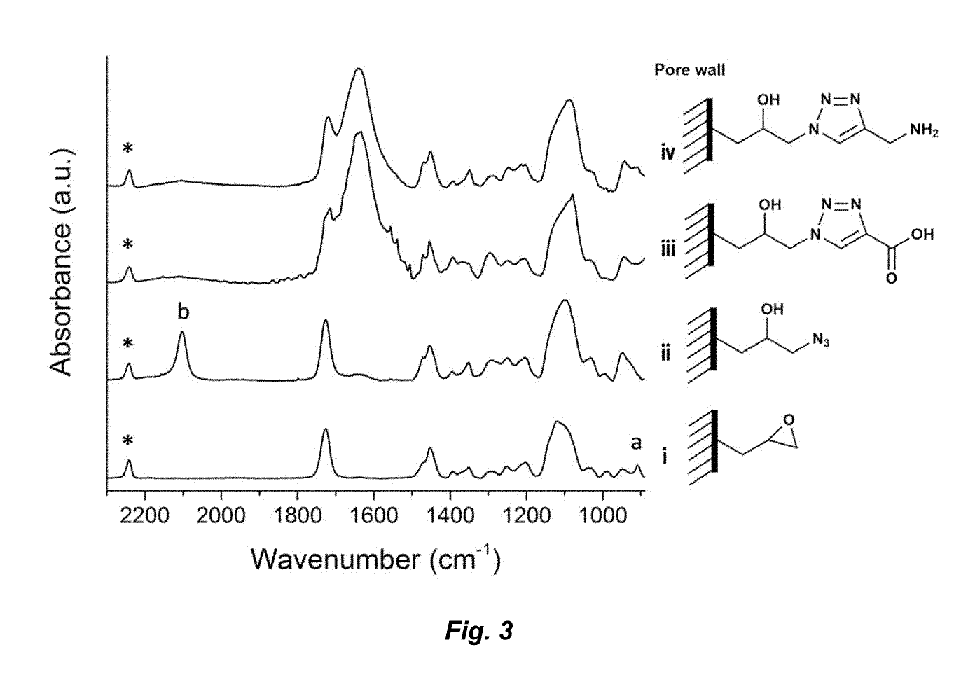

The FT-IR spectra of the charge-functionalized copolymer membranes, the parent P(AN-OEGMA-AHPMA) copolymer membrane, and the P(AN-OEGMA-GMA) copolymer material are compared in FIG. 3. The characteristic epoxide peak at 908 cm⁻¹ (labeled a) in the P(AN-OEGMA-GMA) spectrum (i) disappeared in the P(AN-OEGMA-AHPMA) spectrum (ii).⁴⁵ Concurrently, a distinct azide peak appeared at 2100 cm⁻¹ in spectrum (ii), consistent with the ring-opening reaction of the oxirane groups and the introduction of the azido groups.⁴⁶ These azido groups, which serve as the sites for further functionalization by CuAAC reaction, disappeared after reacting the P(AN-OEGMA-AHPMA) membrane with a propiolic acid (spectrum iii) or a propargylamine solution (spectrum iv). Additionally, several new overlapping peaks appear around 1600 cm⁻¹ after the CuAAC reaction (spectra iii and iv), which may be attributed to carboxyl stretching, N-H bending, and/or the characteristic peaks of triazole.⁴⁷ The results ensured that carboxylic acids and amines had been successfully immobilized at azide active sites dispersed throughout the pores of the membrane. Therefore, copolymer membranes were a promising platform for incorporating patterned charged groups through the use of the CuAAC click reaction.

### Structural and Chemical Characterization of Charge Functionalized Membranes

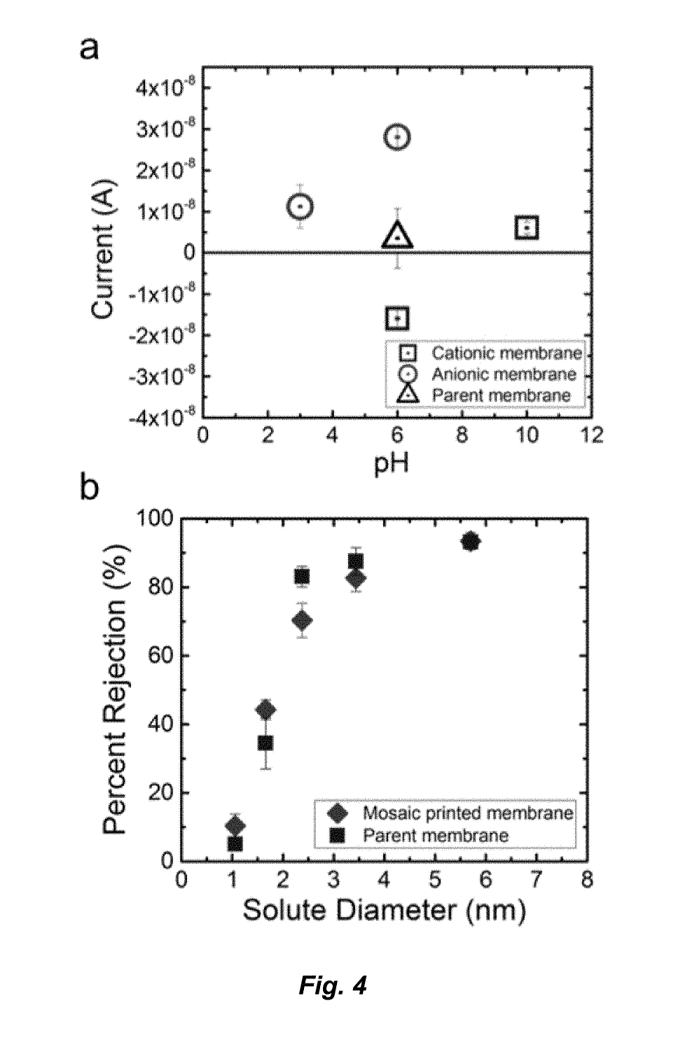

Streaming current measurements were used to demonstrate that the introduction of charged moieties via CuAAC reaction provided control over the ion selectivity of the nanoporous copolymer membranes.⁴⁸ The experimental protocol for measuring streaming current is detailed in prior studies.^{28, 49} Using this protocol, a negative streaming current indicated that the membrane surface is decorated with positive charge, and vice versa. The streaming currents of the parent P(AN-OEGMA-AHPMA) membrane, the amine-functionalized (cationic) membrane, and the acid-functionalized (anionic) membrane are shown as a function of pH in FIG. 4a. The parent membrane produced a streaming current of 3.50×10⁻⁹ A, which is an order of magnitude lower than the current produced by the charge-functionalized membranes, indicating a membrane charge close to neutral. The amine-functionalized membranes are decorated with moieties that protonate, and become positively-charged ammonium in DI water (pH 5.5). The streaming current of −1.60×10⁻⁸ A measured under these conditions is evidence of this positive charge. Under similar conditions, the steaming current measured for the acid-functionalized membrane was equal to 2.80×10⁻⁸ A, indicating the negative charge on the pore walls.

In DI water, the streaming currents for the positively-charged and negatively-charged nanochannels were opposite in sign but similar in magnitude, which is a requirement for the fabrication of the net neutral surface of charge mosaic membranes. Streaming current measurements conducted with pH-adjusted solutions provided further evidence that amine and carboxylic acid groups had been fixed within the nanopores of the membrane. For example, at pH 10 the ammonium groups deprotonate and become amines, the residual charge diminishes, and the streaming current measured for the amine-functionalized membrane became consistent with that of the neutral parent film. When adjusting the solution pH 3, the acid groups are neutralized and the magnitude of the streaming current value fell.

In addition to demonstrating the generation of charge-selective membranes, it was important to ensure that the conversion of the pore wall functionality did not disrupt the well-defined nanostructure of the copolymer membrane. A series of hydraulic permeability and solute rejection experiments were executed to assess the nanostructure of the membrane prior to and following charge functionalization. These measurements were executed in a stirred cell device that used an applied pressure to drive solution through the membrane. The solution that permeated through the membrane was collected in vials at regular intervals and saved for further analysis. The hydraulic permeability of the parent P(AN-OEGMA-AHPMA) membrane was 1.5±1.15 L m⁻² h⁻¹ bar⁻¹.

The pore size determined using the results of sieving experiments conducted with neutral solutes (i.e., sucrose or polyethylene oxide (PEO) molecules of varying molecular weight) dissolved in DI water was equal to ˜5 nm. This value was based on fitting established theories for hindered transport to the percent rejection versus solute size data presented in FIG. 4b. The results for the parent membrane were then compared with those of a charge-functionalized membrane produced using printing technology. After complete charge functionalization, there was no change in the pore size of the membrane, which can be noted from the overlapping data sets in FIG. 4b. Also, the hydraulic permeability remained near 1.0±0.8 L m⁻² h⁻¹ bar⁻¹ indicating that the nanostructure of the membrane remained unchanged during the functionalization process. Therefore, the nanoporous structure is determined by the microphase separation of the copolymer and the pore functionality is determined by the post-synthetic modification of the membrane demonstrating that the membrane morphology and chemical properties can be controlled independently at two separate stages of processing. This orthogonal control over nanostructure and functionality provided by the copolymer materials enables simple and precise adjustments to be made to the membrane properties that otherwise would not be possible.

### Functionalization of Copolymer Membranes Using Printing Devices

The fine control over the membrane properties provided by the copolymer was coupled with inkjet printing technologies to exert further control over the final form and function of the copolymer membrane platform. For example, the number of overprints, which is defined as the number of ink droplets deposited at a single location during the printing process, could be used to tailor the conversion of azide moieties. The number of overprints was proportional to the amount of reactive ink deposited on the membrane surface, which, in turn, controlled the conversion of azide moieties to charged functional groups.

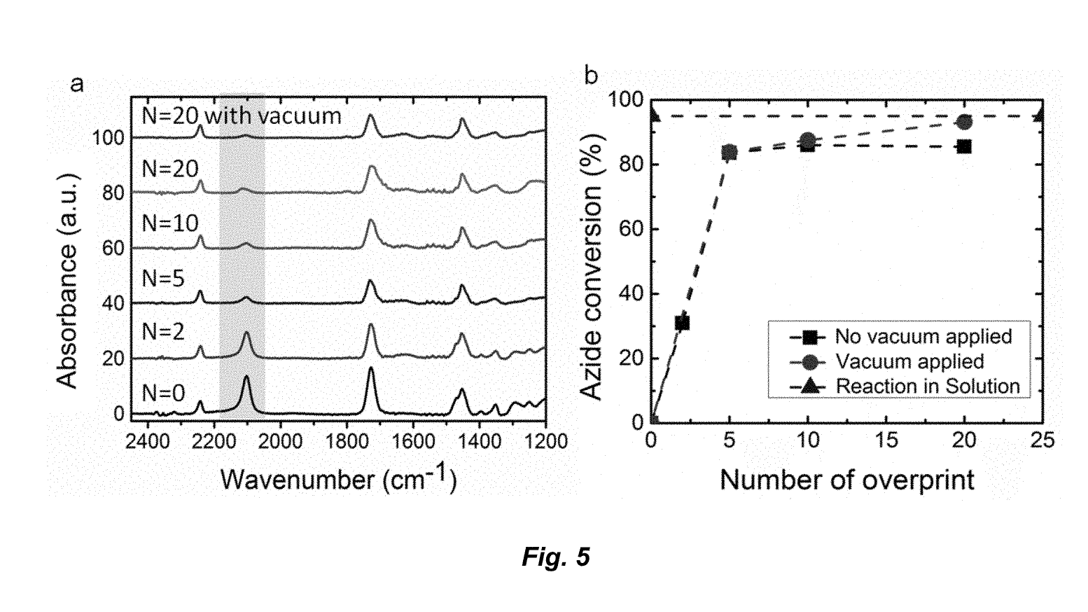

Copolymer membranes prepared with an increasing number of overprints are analyzed in FIG. 5 in order to demonstrate this capability. The progression of conversion with number of overprints was quantified using the FT-IR spectra displayed in FIG. 5a. The area under the azide peak at 2100 cm⁻¹ (grey area) was used to quantify the concentration of azido groups in each membrane; the conversion of azido groups was calculated using the unreacted parent membrane (number of overprints equal to 0) as a baseline. The results of this analysis are shown in FIG. 5b. The conversion of a membrane functionalized by soaking a sample in a large bath of reactive ink for 0.5 h is included because we hypothesize that this is the highest conversion that could be achieved. The conversion of azido groups increased rapidly with the number of overprints and reached 80% after the use of 5 overprints, indicating a rapid and efficient click coupling reaction.

Beyond 5 overprints, the increases in conversion became smaller with increases in the number of overprints. For a membrane without any ballistic mechanisms to drive solution into the bulk of the membrane nanostructure, the conversion at 20 overprints did not reach a level equivalent to that observed for the membrane immersed in the reactive solution. Therefore, vacuum was applied to the membrane during the printing process to facilitate the permeation of the reactive ink solution into the membrane. At less than five overprints, where the reaction kinetics dominate, the use of this vacuum-assisted process did not affect conversion. However, the conversion value measured at 20 overprints for the membrane prepared with the use of the vacuum-assisted process was commensurate with the value achieved when executing the reaction in solution. This can be attributed to the applied vacuum, which provided a mechanism to fully functionalize the membrane surface by pulling jetted ink droplets into the nanopores.

The surface charge density within the nanopores, which is proportional to the extent of azido conversion, increased with the number of overprints applied causing a concomitant increase in the salt rejection capabilities of the charge-functionalized membranes (FIGS. 5c and 5d). This increase in salt rejection at higher surface charge densities is consistent with the Donnan theory. The parent membrane (0 overprints), which had a low surface charge density, showed minimal rejection of either a 10 mM MgCl₂ or a 10 mM Na₂SO₄ feed solution. Upon functionalization with propargylamine (FIG. 5c) or propiolic acid (FIG. 5d) the copolymer membranes prepared with 10 overprints of reactive ink, displayed a notable increase in salt rejection compared to the parent membrane, which is indicative of charged functional groups being introduced on the membrane surface. The salt rejection continued to increase when the number of overprints was increased to 20 and then asymptoted when 50 overprints was implemented. Based on these salt rejection results, 20 overprints were used during the fabrication of mosaic patterned membranes.

High-Throughput Fabrication of Mosaic Membranes

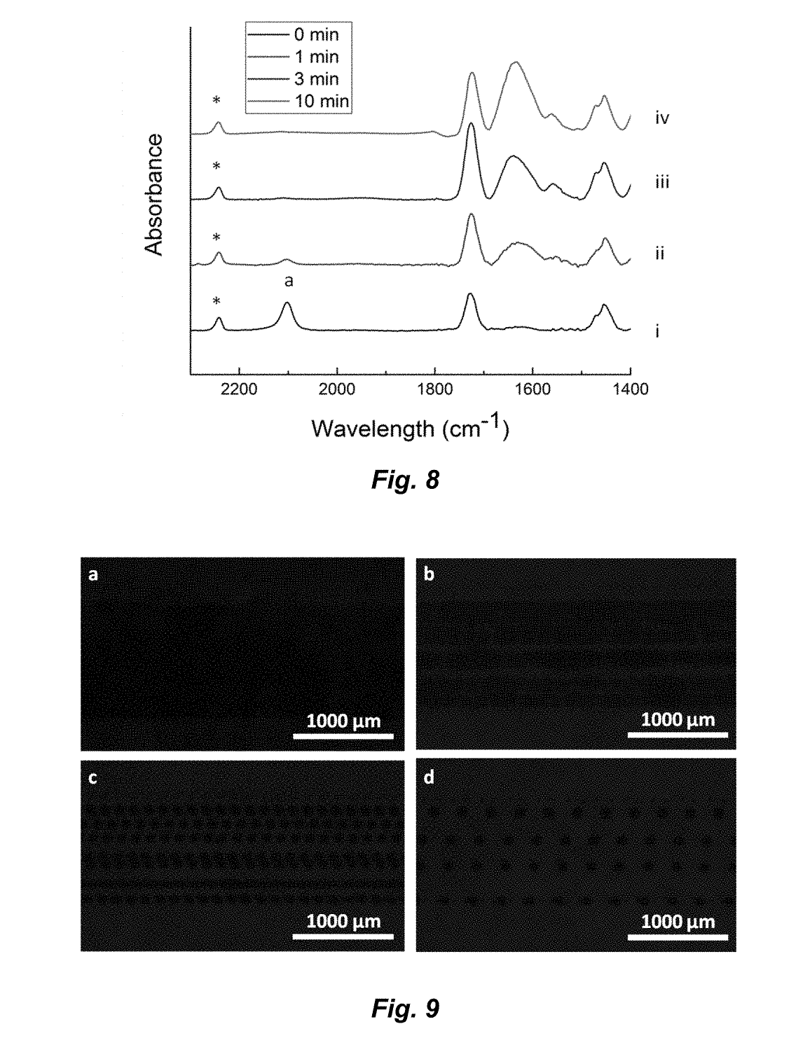

The flexibility and precise control over ink deposition provided by printing devices enabled patterning of the copolymer membranes with bio-inspired mosaic designs. In addition to the geometry of the printed patterns, the conditions used during the printing process, including the droplet size, the resolution, and the number of overprints, were predesigned in the printer input program. By coordinating these parameters appropriately, the chemical nature of the membrane at the nanoscale could be patterned (FIG. 9).

An alkynyl containing sulfo-cyanine5 (ay-sulfo-cyanine5) dye was used to visualize printed patterns and demonstrate our ability to generate chemical patterns on the membrane surface. Ay-sulfo-cyanine5 displayed purple fluorescence under the cy5 channel of a fluorescent microscope while the areas where charged-functional groups were bound to the membrane surface remained dark. This allowed unreacted regions to be distinguished from the regions where the alkyne acid or alkyne amine had already been attached through simple visual inspection. Following the printing of a pattern, the functionalized membranes were soaked in an aqueous ay-sulfo-cyanine5 solution for 24 h to allow the ay-sulfo-cyanine5 to react with the azido groups that remained on the membrane surface. Subsequently, the samples were rinsed with excess water and imaged.

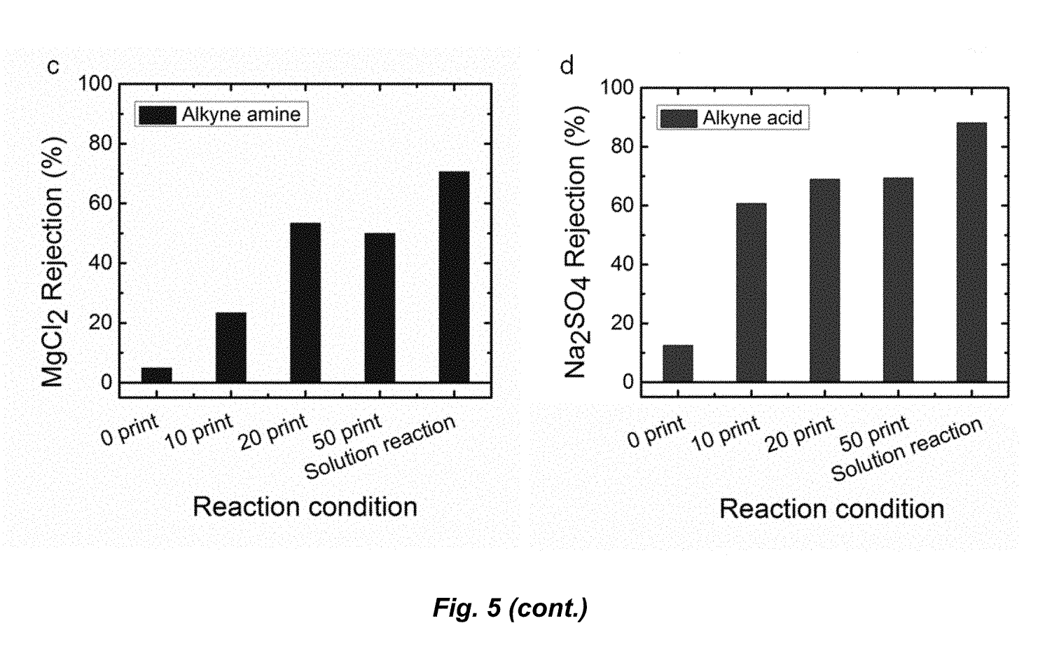

Several control experiments, which are detailed in the Examples below, confirmed that the patterns visualized in the fluorescent microscope were the result of chemical modifications rather than simple physical dyeing of the membrane surface. Fluorescent micrographs of membranes patterned at two different resolutions are shown in FIGS. 6a and 6b. Dotted or striped patterns resulted depending upon the value of the resolution. The membrane surface shown in FIG. 6a was functionalized at a resolution of 90 dots per inch (dpi) using a reactive ink containing propiolic acid. The size of the functionalized regions, which appear dark, are consistent with the programmed droplet diameter of 50 μm.

In FIG. 6b, a resolution of 360 dpi was used to print 200-μm-wide stripes of amine-functionalized domains, which appear dark, onto the membrane surface. These amine-functionalized regions were interspersed with 250-μm-wide stripes of unreacted domains, which appear purple. The distinct dots and stripes that result from the preprogrammed patterns demonstrate that the combination of the CuAAC reactions with inkjet printing devices allowed for the localized conversion of azido moieties to charged-functionalities.

A similar striped pattern was used in the fabrication of charge mosaic membranes. FIG. 6c is a fluorescent micrograph of a charge mosaic membrane that was constructed by printing alternating 200-μm-wide stripes of positively-charged and negatively-charged domains over the surface of the membrane. The almost completely dark surface of this membrane following submersion in the ay-sulfo-cyanine5 solution suggest that full coverage of charged moieties on the membrane was achieved. The counter charged domains fabricated by printing alternating stripes of propargylamine and propiolic acid provided direct pathways for ion transport as demonstrated by their effect on the macroscopic properties of the membrane.

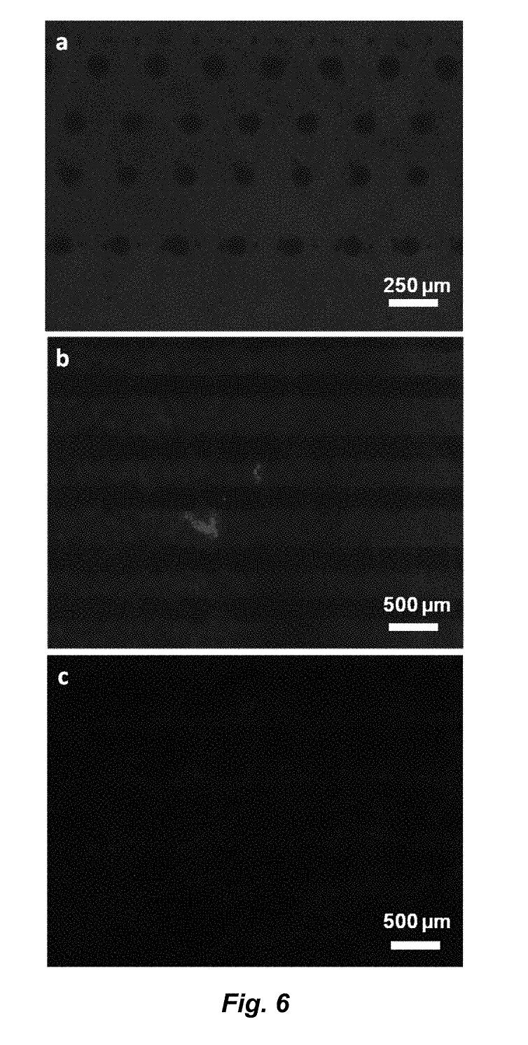

The transport properties of the parent P(AN-OEGMA-AHPMA) membrane, an anionic membrane, a cationic membrane, and a charge mosaic membrane were quantified and compared using solute rejection tests. Each type of membrane was challenged with several feed solutions containing either 10 mM of a salt or 1 g L⁻¹ of sucrose. The results of these experiments are displayed in FIG. 7a, which plots the rejection of the solutes versus membrane type.

Sucrose was chosen as a representative neutral solute because it has a hydrodynamic diameter of 1 nm, which is comparable to the size of most hydrated ions. Across all membrane types the rejection of sucrose was low and ranged from 5-10%, suggesting a low retention based on steric effects. The change in salt rejection observed as charged moieties were fixed on the membrane surface demonstrates the flexibility and utility of changing the membrane chemistry using printing devices. The unreacted parent membrane had a neutral surface. As such, it did not impact the transport of charged solutes as confirmed by the salt rejection values that ranged from 5% to 12%.

Membranes functionalized with a single charge showed a significant increase in salt rejection. Notably, the trend in salt rejection with valence number for divalent co-ions was consistent with the Donnan theory, that is, the membranes rejected divalent co-ions most effectively. The negatively-charged, anionic membrane rejected 87% of the Na₂SO₄ in the feed solution; and the positively-charged, cationic membrane rejected 70% of the MgCl₂ in the feed solution. The charge mosaic membrane covered by equal areas of anionic and cationic domains displayed a low rejection of electrolytes due to the overall neutral surface charge. The rejection of Na₂SO₄ and MgCl₂ was similar to the rejection of sucrose, while the rejection of the 1:1 salts, KCl and MgSO₄, were lower than that of sucrose. Notably, the negative rejection of KCl indicated the preferential permeation of charged ions through the membrane (i.e., negative osmosis) that emerged due to the chemical patterning of the membrane surface.

Salt rejection experiments using feed solutions containing KCl dissolved at concentrations of 0.1 mM, 1 mM, and 10 mM demonstrated conclusively the emergence of negative osmosis. The results of this experimentation are presented in FIG. 7b. As the salt concentration decreased, the salt enrichment of the charge mosaic membrane increased. That is, the rejection becomes more negative at lower salt concentrations. In stark contrast, the salt rejection increased noticeably for both the anionic and cationic membranes as the feed solution concentration decreased.

These results highlighted the critical role that electrostatic interactions play in the performance of the charge mosaic membranes, and indicated the need to operate charge mosaic membranes in the high ion selectivity regime. For example, the transition from the low to high ion selectivity regime can be estimated using Equation 2

$$c = \frac{4 σ}{{Fd}_{pore}} \qquad ( 2 )$$

where c is the concentration at which the membrane transitions to being highly ion-selective, σ is the surface charge density of the nanopore wall, F is Faraday's constant, and dₚₒᵣₑ is the pore diameter.⁵⁰ When the bulk concentration of salt in solution is below c, the membrane will be highly ion selective. The pore diameter of the membrane, 5 nm, was estimated from the neutral solute rejection tests and the surface charge density, 0.01 to 0.001 μcoul cm⁻², was be determined from the streaming current measurements assuming a representative range of pore densities for the copolymer membrane. Using these values, it was estimated that counter-ions would saturate the charged moieties that line the pore walls at a bulk concentration that falls between 0.8 to 0.08 mM, which is entirely consistent with the increase in salt enrichment for the 0.1 mM feed solution. This knowledge provides new design criteria for the generation of mosaic membranes that function effectively over a broad range of salt concentrations.

Conclusion.

Copolymer thin films were designed at the macromolecular scale for the high-throughput fabrication of bio-inspired mosaic membranes. The further development of mosaic membranes, which are able to mediate material transport using chemical as well as steric factors, can help to meet the growing demand for more selective membranes. For example, we demonstrated that when combined with printing technology, the copolymer substrate presented itself as a promising platform for the facile and scalable fabrication of charge mosaic membranes. Through systematic design of the copolymer chemistry, nanoporous membranes lined by reactive azido moieties enabled the fabrication of large areas of mosaic membranes in seconds.

Solute rejection tests with charged and neutral solutes demonstrated that chemically-patterned membranes enabled new, underexplored transport mechanisms to emerge. Notably, negative osmosis allowed electrolytes to permeate more rapidly through the mosaic membrane than smaller neutral molecules. The versatility of the copolymer materials, and ease with which their nanostructure and chemistry can be tailored through systematic macromolecular engineering, will allow them serve as a platform for the realization of next-generation mosaic membranes that can address critical separations in the chemical and pharmaceutical industry.

The following Examples are intended to illustrate the above invention and should not be construed as to narrow its scope. One skilled in the art will readily recognize that the Examples suggest many other ways in which the invention could be practiced. It should be understood that numerous variations and modifications may be made while remaining within the scope of the invention.

### EXAMPLES

All chemicals were purchased from Sigma-Aldrich unless otherwise noted. A Millipore water purification system (Milli Q Advantage A10, Millipore Corporation, MA) was used to prepare deionized water (DI water). The poly(acrylonitrile-co-oligo(ethylene glycol) methyl ether methacrylate-co-glycidyl methacrylate) (P(AN-OEGMA-GMA)) copolymer was synthesized using a free radical copolymerization as detailed in a prior work.³⁴ The poly(acrylonitrile-co-[oligo(ethylene glycol) methyl ether methacrylate]-co-(3-azido-2-hydroxypropylmethacrylate)) P(AN-OEGMA-AHPMA) copolymer was then prepared by reacting P(AN-OEGMA-GMA) with sodium azide. A mixture of P(AN-OEGMA-GMA), sodium azide (NaN₃), and ammonium chloride (NH₄Cl) were dissolved in dimethylformamide (DMF) at a mole ratio of PGMA:NaN₃:NH₄Cl=1:5:7. The solution was reacted at 40° C. for 72 hrs. After reaction, the copolymer was precipitated in DI water and dried in a vacuum oven for 24 hrs. The chemical structure of the copolymer was confirmed using ¹H NMR spectroscopy (Bruker Advance III HD400) at each step of the process. Deuterated dimethyl sulfoxide was used as the solvent.

This disclosure provides: Estimation of the Membrane Surface Charge Density; ¹H NMR spectra of the copolymers; timed series characterization of CuAAC click reactions; micrographs of 1000-μm-wide stripes printed at different resolutions and number of overcoats; FT-IR spectra and fluorescent micrograph of copolymer membranes following exposure to a reactive ink solution containing the fluorescent ay-sulfo-cyanine5 dye.

### Example 1. Polymer Synthesis and Membrane Fabrication

Membranes were fabricated from the P(AN-OEGMA-AHPMA) copolymer using a non-solvent induced phase separation (NIPS) method. The copolymer was dissolved in dimethyl sulfoxide (DMSO) to form a 18.5% (by weight) copolymer solution. After becoming homogenous in appearance, the solution was stirred slowly for 24 h to release dissolved gases. The resulting solution was spread on a PAN-400 (Nanostone Water, Inc., Calif.) membrane support using a doctor blade set at a gate height of 63 μm to form a thin film. Solvent was allowed to evaporate for 5 min before plunging the system into an isopropanol bath to precipitate the copolymer and fix its nanostructure in place. Membranes were placed in a Petri dish filled with DI water and stored until further use.

Membrane Functionalization.

Following fabrication, cationic or anionic functional groups were incorporated into the nanostructured membranes using copper(I)-catalyzed azide-alkyne cycloaddition (CuAAC) “click” reactions with propargylamine or propiolic acid, respectively. Reactive ink solutions were prepared by dissolving 0.8 M alkynyl-terminated reactant, 20 mM CuSO₄.5H₂O, and 60 mM ascorbic acid in DI water. For inks containing propargylamine, 10 mM hydrochloric acid was included to prevent the precipitation of copper. The rapid reaction between the azido groups in the nanopores of the membrane and the alkynyl-functionalized charged groups deposited onto the membrane surface produced charge selective domains. Solutions containing propargylamine introduced positive charge within the nanopores and solutions containing propiolic acid resulted in negatively-charged domains. For samples reacted in solution, sections of a P(AN-OEGMA-AHPMA) membrane were placed into a Petri dish and 10 mL of the reactive ink solution was added to cover membrane.

An Epson Color Print C88+ printer was used to deposit the reactive ink solutions on the membrane surface in order to generate chemically-patterned membranes. The P(AN-OEGMA-AHPMA) membrane was attached to plastic sleeve that was connected to the in-house vacuum line (12 psi pressure). This vacuum device was fed to the printer. The reactive ink solutions were filtered through 1 μm syringe filters (VWR International) and then loaded into ink cartridges. Depositing one type of reactive solution across the whole surface of a membrane generated single charge-functionalized membranes. Charge mosaic membranes were generated by printing alternating stripes of reactive inks containing positively-charged and negatively-charged moieties.

Chemical Characterization and Streaming Current Measurement of Membrane.

The chemical structures of the membranes were characterized at different stages of the fabrication process using Fourier transform infrared (FT-IR) spectroscopy (Jasco FT/IR-6300 spectrophotometer). A small section of membrane was dried in a vacuum oven at room temperature prior to analysis in order to remove residual water. The membranes were scanned over the range of wavenumbers from 650 cm⁻¹≤v≤4500 cm⁻¹.

Streaming-current measurements were used to determine surface charge of the copolymer membranes. A membrane was sandwiched in a U-tube cell and sealed with O-rings. Both sides of the cell were filled with a 10 mM potassium chloride solution. The positive and negative terminals of a sourcemeter (Keithley 2400 sourcemeter) were connected to each side of the cell. An applied pressure of 15 psi pressure was then applied on the side of the cell connected to the positive terminal of the sourcemeter in order to drive the flow of solution through the membrane. The value of the current and pressure measured while solution was flowing through the membrane was recorded using LabVIEW software programs.

Fluorescent Imaging of Membranes.

Chemical patterns printed on copolymer membrane were imaged using fluorescent microscopy. An alkynyl containing sulfo-cyanine5 (ay-sulfo-cyanine5) dye (Lumiprobe, Fla.) was used to react with the azido moieties available on the membrane surface. Following printing, functionalized membranes were immersed in a reactive solution containing 10 μM ay-sulfo-cyanine5, 20 mM CuSO₄.5H₂O, and 60 mM ascorbic acid then left at room temperature for 24 hours. After removing the membranes from the reactive solution, the membranes were rinsed with excess DI water to remove any residual fluorescent dye that was not covalently bonded to the membrane surface. Membranes were then visualized using a fluorescent microscope (EVOS FL Auto, Thermo Fisher Scientific) with the Cy5 channel.

Transport Tests.

Membrane performance was tested using an Amicon 8010 stirred cell (Millipore). A membrane 1-inch in diameter was placed in the stirred cell with the active layer facing up. The stirred cell was then filled with 10 mL of a feed solution. Nitrogen gas was used to apply pressure and drive solution through the membrane. For hydraulic permeability measurements, DI water was used as the feed solution. The mass of the permeated water was recorded as a function of time at applied pressures that ranged from 20 to 60 psi.

For neutral solute rejection tests, the membranes were challenged with feed solutions containing 1 g L⁻¹ polyethylene oxide (PEO) with molecular weights of 1.1, 2.1, 4.0 and 9.8 kDa (Polymer Source Inc., Montreal, Quebec, Canada) and sucrose, separately. The cell was stirred at 300 rpm during these tests to mitigate the effects of concentration polarization. The solutions that permeated through the membrane were collected in scintillation vials and stored in a fridge until further analysis. The stirred cell was rinsed thoroughly with DI water between each experiment. The concentration of PEO and sucrose in the permeate solutions was measured with Shimadzu TOC-TN Organic Carbon Analyzer.

In salt rejection tests, membranes were challenged with feed solutions containing potassium chloride, magnesium chloride, magnesium sulfate, or sodium sulfate dissolved in DI water at concentrations of 0.1, 1, or 10 mM. The concentrations of potassium chloride, magnesium chloride, and magnesium sulfate were measured using inductively coupled plasma optically emission spectroscopy (ICP-OES) (Perkin Elmer Optima 8000) to quantify the elemental concentration of K⁺ or Mg²⁺, respectively. The concentration of sodium sulfate was measured by ion chromatography (IC) (Dionex ICS-5000) to quantify concentration of Na⁺. Based on the measured concentrations in the feed and permeate solutions, the rejection value was calculated as:

$$R ( \% ) = ( 1 - \frac{{C}_{p}}{{C}_{f}} ) \times 100 \qquad ( 1 )$$

where Cₚ represents permeate solution concentration and C_{f} represents feed solution concentration.

### Example 2. Analysis of Copolymer Nanofilters with Charge-Patterned Domains

Estimation of the Membrane Surface Charge Density. The streaming current of a membrane, I, determined at an applied pressure, ΔP, is related to the zeta potential, ζ, of the membrane surface through equation S1 (Kirby et al., Electrophoresis 2004, 25, 203-213):

$$I = \frac{ɛζΔ P}{η𝓁} {A}_{p} \qquad ( S1 )$$

where, ε is permittivity of water (6.93×10⁻¹⁰ C V⁻¹ m⁻¹), η is viscosity of the solution (1 mPa s), l is the thickness of the membrane (10 μm), and Aₚ is the total cross sectional area of the pores in the membrane. This area can be estimated from membrane area, Aₘ (0.126 cm²), the number density of pores, ρ=1×10¹⁰-1×10¹¹ pores cm⁻¹ (Bernards et al., Soft Matter 2010, 6, 1621-1631), and the pore diameter, dₚₒᵣₑ=5 nm, according to Equation S2:

$${A}_{p} = \frac{{A}_{m} ρπ {d}_{pore}^{2}}{4} \qquad ( S2 )$$

Furthermore, the zeta potential of the membrane can be related to the surface charge density, σ, of the membrane according to the equation (Miller et al., J. Am. Chem. Soc. 2004, 126, 6226-6227):

$$σ = \frac{ɛζ}{{κ}^{- 1}} \qquad ( S3 )$$

where κ⁻¹ is the Debye length of a 10 mM potassium chloride solution (3.1 nm).

By combining Equation S1 through Equation S3, the surface charge density of the membrane is related to the experimentally measured value of the streaming current to pressure ratio, I ΔP⁻¹=1.86×10⁻⁹ A psi⁻¹.

$$σ = \frac{I}{Δ P} \frac{4 η𝓁}{{κ}^{- 1} {A}_{m} ρπ {d}_{pore}^{2}} \qquad ( S4 )$$

Therefore, the surface charge density of the membrane is estimated to be in the range of 0.01-0.001 μcoul cm⁻².

In FIG. 8, timed series characterization of copper(I)-catalyzed azide-alkyne cycloaddition (CuAAC) click reactions for P(AN-OEGMA-AHPMA) membranes. The conversion of the azido group was quantified using the characteristic peak a at 2100 cm⁻¹ in the FT-IR sprectra (Shi et al., J. Polym. Sci., Part A: Polym. Chem. 2015, 53, 239-248). The P(AN-OEGMA-AHPMA) membrane, which corresponds to absorption spectrum i, was analyzed as the control (i.e., 0% conversion). The CuAAC reaction initiates when the membrane contacts the reactive ink solution. After 1 min exposure (spectrum ii) to the reactive ink solution, the characteristic azido peak is significantly diminished. At 3 min exposure (spectrum iii), nearly complete conversion is observed due to the disappearance of the characteristic azido peak.

In FIG. 9, printing a 1000-μm-wide stripe using different resolutions (i.e., dots per inch (dpi)) and number of overcoats. The printer was programmed to produce a 1000-μm-wide stripe, which appears dark in the micrographs, using a series of operating parameters. a. 20 overcoats 360 dpi, b. 10 overcoats 360 dpi, c. 10 overcoats 180 dpi, d. 10 overcoats 90 dpi. At low resolution, single droplets of solution produce distinct circles. As the resolution is increased, the droplets begin to overlap and eventually form solid lines at sufficiently high resolution. Based on these results, a resolution of 360 dpi and 20 overprints was used to produce bio-inspired mosaic membrane structures.

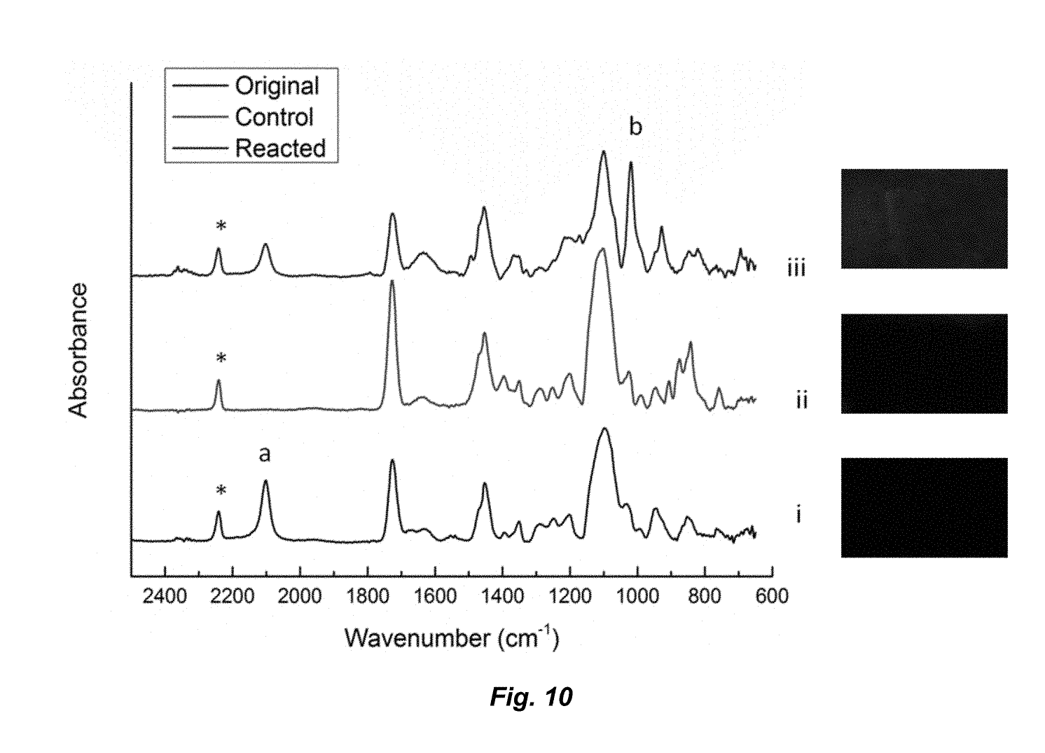

In FIG. 10, the FT-IR spectra and corresponding fluorescent micrograph of various copolymer membranes after exposure to a reactive ink solution containing the fluorescent ay-sulfo-cyanine5 dye. The parent P(AN-OEGMA-AHPMA) membrane before any patterning was used as a baseline (lowest line). A P(AN-OEGMA-AHPMA) membrane that was chemically-modified by printing a reactive ink solution containing propiolic acid was analyzed as the control (middle line). Subsequently, both the parent and control were immersed in the same solution of ay-sulfo-cyanine5 and catalyst for 24 hours, removed, rinsed, and soaked in DI water to remove physisorped dye. Neither the parent membrane or the control membrane showed any fluorescence signal in the cy5 channel. However, the parent membrane exposed to the reactive ink solution containing ay-sulfo-cyanine5 appeared purple in color.

This result is consistent with the FTIR spectra of the three membranes. The characteristic azido peak at 2100 cm⁻¹ is evident in the spectrum of the parent membrane but is not observed in the spectrum of the control membrane. The intensity of the azido peak labeled a is reduced in the spectrum for the ay-sulfo-cyanine5-functionalized membrane (top line). Moreover, a peak characteristic of sulfonate groups, labeled b, appeared at 1008 cm⁻¹, indicating that the dye was chemically bonded to the membrane not physically absorbed sulfo-cyanine5 (Puttnam et al., J. Soc. Cosmet. Chem. 1966, 17, 391-400). No sulfonate peak appeared in the spectrum of the control membrane indicating all physisorped dye was rinsed from the membrane. The incomplete conversion of the ay-sulfo-cyanine5-functionalized membrane could be attributed to the large size of the dye relative to the pore diameter making some of the azido moieties inaccessible to the dye.

### CITATIONS

(1) Elimelech, M.; Phillip, W. A., The Future of Seawater Desalination: Energy, Technology, and the Environment. Science 2011, 333, 712-717.
(2) Shannon, M. A.; Bohn, P. W.; Elimelech, M.; Georgiadis, J. G.; Marinas, B. J.; Mayes, A. M., Science and Technology for Water Purification in the Coming Decades. Nature 2008, 452, 301-310.
(3) Krieg, E.; Weissman, H.; Shirman, E.; Shimoni, E.; Rybtchinski, B., A Recyclable Supramolecular Membrane for Size-Selective Separation of Nanoparticles. Nat. Nanotechnol. 2011, 6, 141-146.
(4) van Reis, R.; Zydney, A., Bioprocess Membrane Technology. J. Membr. Sci. 2007, 297, 16-50.
(5) Zydney, A. L., Membrane Technology for Purification of Therapeutic Proteins. Biotechnol. Bioeng. 2009, 103, 227-230.
(6) Mehta, A.; Zydney, A. L., Permeability and Selectivity Analysis for Ultrafiltration Membranes. J. Membr. Sci. 2005, 249, 245-249.
(7) Geise, G. M.; Lee, H. S.; Miller, D. J.; Freeman, B. D.; McGrath, J. E.; Paul, D. R., Water Purification by Membranes: the Role of Polymer Science. J. Polym. Sci., Part B: Polym. Phys. 2010, 48, 1685-1718.
(8) Zeman, L. J.; Zydney, A. L., Microfiltration and ultrafiltration: principles and applications. Marcel Dekker: New York, 1996
(9) Zhang, Y; Sargent, J. L.; Boudouris, B. W.; Phillip, W. A., Nanoporous Membranes Generated from Self-Assembled Block Polymer Precursors: Quo Vadis? J. Appl. Polym. Sci. 2015, 132, 41683-41699.
(10) Werber, J. R.; Osuji, C. O.; Elimelech, M., Materials for Next-Generation Desalination and Water Purification Membranes. Nat. Rev. Mater. 2016, 1, 16018-16034.
(11) Feng, X.; Nejati, S.; Cowan, M. G.; Tousley, M. E.; Wiesenauer, B. R.; Noble, R. D.; Elimelech, M.; Gin, D. L.; Osuji, C. O., Thin Polymer Films with Continuous Vertically Aligned 1 nm Pores Fabricated by Soft Confinement. ACS Nano 2015, 10, 150-158.
(12) Park, S.; Lee, D. H.; Xu, J.; Kim, B.; Hong, S. W.; Jeong, U.; Xu, T.; Russell, T. P., Macroscopic 10-Terabit-per-Square-Inch Arrays from Block Copolymers with Lateral Order. Science 2009, 323, 1030-1033.
(13) Sholl, D. S.; Lively, R. P., Seven Chemical Separations to Change the World. Nature 2016, 532, 435-437.
(14) Striemer, C. C.; Gaborski, T. R.; McGrath, J. L.; Fauchet, P. M., Charge and Size-Based Separation of Macromolecules Using Ultrathin Silicon Membranes. Nature 2007, 445, 749-753.
(15) Cheng, C.; Yaroshchuk, A.; Bruening, M. L., Fundamentals of Selective Ion Transport through Multilayer Polyelectrolyte Membranes. Langmuir 2013, 29, 1885-1892.
(16) Qiu, X.; Yu, H.; Karunakaran, M.; Pradeep, N.; Nunes, S. P.; Peinemann, K.-V, Selective Separation of Similarly Sized Proteins with Tunable Nanoporous Block Copolymer Membranes. ACS Nano 2012, 7, 768-776.
(17) Liu, Z.; Luo, F.; Ju, X. J.; Xie, R.; Luo, T.; Sun, Y M.; Chu, L. Y, Positively K+-Responsive Membranes with Functional Gates Driven by Host-Guest Molecular Recognition. Adv. Funct. Mater. 2012, 22, 4742-4750.
(18) Weidman, J. L.; Mulvenna, R. A.; Boudouris, B. W.; Phillip, W. A., Nanostructured Membranes from Triblock Polymer Precursors as High Capacity Copper Adsorbents. Langmuir 2015, 31, 11113-11123.
(19) Gadsby, D. C., Ion Channels versus Ion Pumps: the Principal Difference, in Principle. Nat. Rev. Mol. Cell Biol. 2009, 10, 344-352.
(20) Hub, J. S.; De Groot, B. L., Mechanism of Selectivity in Aquaporins and Aquaglyceroporins. Proc. Natl. Acad. Sci. 2008, 105, 1198-1203.
(21) Kumar, M.; Grzelakowski, M.; Zilles, J.; Clark, M.; Meier, W., Highly Permeable Polymeric Membranes Based on the Incorporation of the Functional Water Channel Protein Aquaporin Z. Proc. Natl. Acad. Sci. 2007, 104, 20719-20724.
(22) Shen, Y; Si, W.; Erbakan, M.; Decker, K.; De Zorzi, R.; Saboe, P. O.; Kang, Y J.; Majd, S.; Butler, P. J.; Walz, T., Highly Permeable Artificial Water Channels that can Self-Assemble into Two-Dimensional Arrays. Proc. Natl. Acad. Sci. 2015, 112, 9810-9815.
(23) He, Z.; Zhou, J.; Lu, X.; Corry, B., Bioinspired Graphene Nanopores with Voltage-Tunable Ion Selectivity for Na+ and K+. ACS Nano 2013, 7, 10148-10157.
(24) Tang, C.; Zhao, Y.; Wang, R.; Hélix-Nielsen, C.; Fane, A., Desalination by Biomimetic Aquaporin Membranes: Review of Status and Prospects. Desalination 2013, 308, 34-40.
(25) Zhao, J.; Zhao, X.; Jiang, Z.; Li, Z.; Fan, X.; Zhu, J.; Wu, H.; Su, Y; Yang, D.; Pan, F., Biomimetic and Bioinspired Membranes: Preparation and Application. Prog. Polym. Sci. 2014, 39, 1668-1720.
(26) Sanchez, C.; Arribart, H.; Guille, M. M. G., Biomimetism and Bioinspiration as Tools for the Design of Innovative Materials and Systems. Nat. Mater. 2005, 4, 277-288.
(27) Carr, C. W.; Sollner, K., The Electroosmotic Effects Arising from the Interaction of the Selectively Anion and Selectively Cation Permeable Parts of Mosaic Membranes. Biophys. J. 1964, 4, 189-201.
(28) Higa, M.; Masuda, D.; Kobayashi, E.; Nishimura, M.; Sugio, Y.; Kusudou, T.; Fujiwara, N., Charge Mosaic Membranes Prepared from Laminated Structures of PVA-Based Charged Layers: 1. Preparation and Transport Properties of Charged Mosaic Membranes. J. Membr. Sci. 2008, 310, 466-473.
(29) Weinstein, J. N.; Bunow, B. J.; Caplan, S. R., Transport Properties of Charge-Mosaic Membranes I. Theoretical Models. Desalination 1972, 11, 341-377.
(30) Rajesh, S.; Yan, Y.; Chang, H.-C.; Gao, H.; Phillip, W. A., Mixed Mosaic Membranes Prepared by Layer-by-Layer Assembly for Ionic Separations. ACS Nano 2014, 8, 12338-12345.
(31) Fujimoto, T.; Ohkoshi, K.; Miyaki, Y.; Nagasawa, M., A New Charge-Mosaic Membrane from a Multiblock Copolymer. Science 1984, 224, 74-76.
(32) Pendergast, M. M.; Dorin, R. M.; Phillip, W. A.; Wiesner, U.; Hoek, E. M., Understanding the Structure and Performance of Self-Assembled Triblock Terpolymer Membranes. J. Membr. Sci. 2013, 444, 461-468.
(33) Dorin, R. M.; Sai, H.; Wiesner, U., Hierarchically Porous Materials from Block Copolymers. Chem. Mater. 2013, 26, 339-347.
(34) Qu, S.; Dilenschneider, T.; Phillip, W. A., Preparation of Chemically-Tailored Copolymer Membranes with Tunable Ion Transport Properties. ACS Appl. Mater. Interfaces 2015, 7, 19746-19754.
(35) Zhang, Q.; Gu, Y; Li, Y. M.; Beaucage, P. A.; Kao, T.; Wiesner, U., Dynamically Responsive Multifunctional Asymmetric Triblock Terpolymer Membranes with Intrinsic Binding Sites for Covalent Molecule Attachment. Chem. Mater. 2016, 28, 3870-3876
(36) Vannucci, C.; Taniguchi, I.; Asatekin, A., Nanoconfinement and Chemical Structure Effects on Permeation Selectivity of Self-Assembling Graft Copolymers. ACS Macro Lett. 2015, 4, 872-878.
(37) Akthakul, A.; Salinaro, R. F.; Mayes, A. M., Antifouling Polymer Membranes with Subnanometer Size Selectivity. Macromolecules 2004, 37, 7663-7668.
(38) Rathee, V. S.; Qu, S.; Phillip, W. A.; Whitmer, J. K., A Coarse-Grained Thermodynamic Model for the Predictive Engineering of Valence-Selective Membranes. Mol. Syst. Des. Eng. 2016, 1, 301-312.
(39) Asatekin, A.; Kang, S.; Elimelech, M.; Mayes, A. M., Anti-Fouling Ultrafiltration Membranes Containing Polyacrylonitrile-graft-Poly(ethylene oxide) Comb Copolymer Additives. J. Membr. Sci. 2007, 298, 136-146.
(40) Tornøe, C. W.; Christensen, C.; Meldal, M., Peptidotriazoles on Solid Phase:[1, 2, 3]-Triazoles by Regiospecific Copper (I)-Catalyzed 1, 3-Dipolar Cycloadditions of Terminal Alkynes to Azides. J. Org. Chem. 2002, 67, 3057-3064.
(41) Hein, J. E.; Fokin, V. V, Copper-Catalyzed Azide-Alkyne Cycloaddition (CuAAC) and Beyond: New Reactivity of Copper (I) Acetylides. Chem. Soc. Rev. 2010, 39, 1302-1315.
(42) Castro, V; Rodriguez, H.; Albericio, F., CuAAC: an Efficient Click Chemistry Reaction on Solid Phase. ACS Comb. Sci. 2015, 18, 1-14.
(43) Cai, T.; Neoh, K.; Kang, E.; Teo, S., Surface-Functionalized and Surface-Functionalizable Poly (vinylidene fluoride) Graft Copolymer Membranes via Click Chemistry and Atom Transfer Radical Polymerization. Langmuir 2011, 27, 2936-2945.
(44) Shi, Y.; Graff, R. W.; Cao, X.; Wang, X.; Gao, H., Chain-Growth Click Polymerization of AB2 Monomers for the Formation of Hyperbranched Polymers with Low Polydispersities in a One-Pot Process. Angew. Chem., Int. Ed. 2015, 127, 7741-7745.
(45) Iha, R. K.; Wooley, K. L.; Nystrom, A. M.; Burke, D. J.; Kade, M. J.; Hawker, C. J., Applications of Orthogonal “Click” Chemistries in the Synthesis of Functional Soft Materials. Chem. Rev. 2009, 109, 5620-5686.
(46) Rostovtsev, V. V; Green, L. G.; Fokin, V. V.; Sharpless, K. B., A Stepwise Huisgen Cycloaddition Process: Copper (I)-Catalyzed Regioselective “Ligation” of Azides and Terminal Alkynes. Angew. Chem., Int. Ed. 2002, 114, 2708-2711.
(47) Barbey, R.; Klok, H.-A., Room Temperature, Aqueous Post-Polymerization Modification of Glycidyl Methacrylate-Containing Polymer Brushes Prepared via Surface-Initiated Atom Transfer Radical Polymerization. Langmuir 2010, 26, 18219-18230.
(48) Shi, Y; Wang, X.; Graff, R. W.; Phillip, W. A.; Gao, H., Synthesis of Degradable Molecular Brushes via a Combination of Ring-Opening Polymerization and Click Chemistry. J. Polym. Sci., Part A: Polym. Chem. 2015, 53, 239-248.
(49) Li, H.; Zheng, Q.; Han, C., Click Synthesis of Podand Triazole-Linked Gold Nanoparticles as Highly Selective and Sensitive Colorimetric Probes for Lead (II) Ions. Analyst 2010, 135, 1360-1364.
(50) Schoch, R. B.; Han, J.; Renaud, P., Transport Phenomena in Nanofluidics. Rev. Mod. Phys. 2008, 80, 839-883.
(51) Gao, P.; Hunter, A.; Benavides, S.; Summe, M. J.; Gao, F.; Phillip, W. A., Template Synthesis of Nanostructured Polymeric Membranes by Inkjet Printing. ACS Appl. Mater. Interfaces 2016, 8, 3386-3395.
(52) Yan, Y; Wang, L.; Xue, J.; Chang, H.-C., Ion Current Rectification Inversion in Conic Nanopores: Nonequilibrium Ion Transport Biased by Ion Selectivity and Spatial Asymmetry. J. Chem. Phys. 2013, 138, 044706.

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

All publications, patents, and patent documents are incorporated by reference herein, as though individually incorporated by reference. No limitations inconsistent with this disclosure are to be understood therefrom. The invention has been described with reference to various specific and preferred embodiments and techniques. However, it should be understood that many variations and modifications may be made while remaining within the spirit and scope of the invention.

What is claimed is:

1. A membrane comprising a plurality of pores, wherein active chemical moieties are covalently attached to the pore wall of one or more pores by one or more intermediary copolymer groups, and the membrane is selective toward the separation of particles of similar size based on particle charge.

2. The membrane of claim 1 wherein the active chemical moieties comprise azido groups, hydroxyl groups, triazole groups, amine groups, carboxyl groups, or a combination thereof.

3. The membrane of claim 2 wherein the active chemical moieties comprise moiety I, moiety II, or a combination thereof: 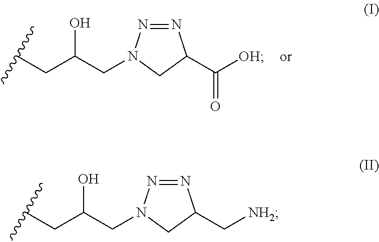 [SMILES: *CC(O)CN1CC(C(=O)O)N=N1 ; *CC(O)CN1CC(CN)N=N1]
or a carboxylate anion or ammonium cation thereof, respectively.

4. The membrane of claim 3 wherein the membrane comprises ammonium cations of active chemical moieties of moiety II and the membrane comprises a residual positive charge.

5. The membrane of claim 3 wherein the membrane comprises carboxylate anions of active chemical moieties of moiety I and the membrane comprises a residual negative charge.

6. The membrane of claim 3 wherein the membrane comprises pores having residual positive charges and other pores having residual negative charges.

7. The membrane of claim 3 wherein the intermediary copolymer comprises a copolymer of Formula III: 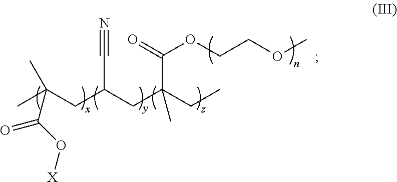
wherein
each X is independently an active chemical moiety comprising moiety I, moiety II, or a carboxylate anion or ammonium cation thereof, respectively;
n is about 5 to about 5,000;
x is about 5 to about 10,000;
y is about 5 to about 10,000; and
z is about 5 to about 10,000;
wherein one or more nitrile groups of blocky form a covalent bond with a pore wall of the membrane.

8. The membrane of claim 7 wherein the surface charge density of the membrane is about 0.01 to about 0.001 μcoul cm⁻².

9. The membrane of claim 8 wherein the average pore sizes of the membrane are about 3 nm to about 7 nm.

10. The membrane of claim 1 wherein the surface charge density of the membrane is about 0.01 to about 0.001 μcoul cm⁻².

11. The membrane of claim 10 wherein the average pore sizes of the membrane are about 3 nm to about 7 nm.

12. A filtration membrane comprising a plurality of pores wherein a block copolymer is attached to the sidewall of one or more pores, free ends of the copolymer extending into the pore are functionalized by anionic charged species, cationic charged species, or a combination thereof, and wherein different regions of the membrane comprises pores with positive net charges and negative net charges, respectively.

13. The membrane of claim 12 wherein the copolymer comprises at least three polymer blocks, wherein a first block is hydrophilic, a second block is hydrophobic, and the third block is functionalized with a positively or negatively charged specie.

14. The membrane of claim 13 wherein one of the blocks comprises poly(ethylene oxide).

15. The membrane of claim 14 wherein the copolymer is functionalized P(AN-OEGMA-AHPMA).

16. A method of forming a mosaic polymer membrane comprising:
dissolving P(AN-OEGMA-AHPMA) copolymer in a suitable solvent to provide a solution;
combining the solution of P(AN-OEGMA-AHPMA) copolymer with a membrane substrate that has a plurality of pores;
fabricating the polymer membrane by bonding polyacrylonitrile moieties of the P(AN-OEGMA-AHPMA) polymer to the sidewalls of one or more pores of the membrane substrate; and
functionalizing azido groups of the copolymer by a CuAAC click reaction with a charged species;
wherein different regions of the membrane are functionalized with either positive or negative charged species.

17. The method of claim 16 where the charges species comprise propargylamine, propiolic acid, or a combination thereof.

18. The method of claim 16 where azido groups are functionalized by printing the charged species in a pattern on the polymerized membrane substrate.

19. A method of rapidly preparing an area of a patterned membrane comprising printing a reactive ink solution onto a suitable porous membrane to provide a mosaic membrane comprising the membrane of claim 1, for the selective filtration of particles of similar size based on particle charge.

20. The method of claim 19 wherein the printing provides rows of multiple oppositely-charged materials resulting in a membrane having negative osmosis properties.
